(19) United States
(12) Patent Application Publication
(10) Pub. No.: US 2015/0096963 A1
(43) Pub. Date: Apr. 9, 2015

(54) LASER CLADDING WITH PROGRAMMED BEAM SIZE ADJUSTMENT

(71) Applicants: Gerald J. Bruck, Oviedo, FL (US); Ahmed Kamel, Orlando, FL (US)

(72) Inventors: Gerald J. Bruck, Oviedo, FL (US); Ahmed Kamel, Orlando, FL (US)

(21) Appl. No.: 14/045,818

(22) Filed: Oct. 4, 2013

(51) Int. Cl. B23K 26/00

(52) U.S. Cl. CPC B23K 26/0081
USPC 219/121.61

(57) ABSTRACT

A method for heating an irregularly shaped target surface (28, 36) with an energy beam (12, 48) with a controlled power density as the beam progresses across the surface in order to control a cladding process. In one embodiment, widths (y) of respective rectangular diode laser beam images (22, 24, 26) are controlled in response to a local width of a gas turbine blade tip (20), and a power level of the diode laser is linearly controlled in response to the width of the respective image in order to maintain an essentially constant power density across the blade tip. In another embodiment, the width and power level of a continuous laser beam image (34) are controlled in response to changes in the local surface shape in order to produce a predetermined power density as the image is swept across the surface.

### FIELD OF THE INVENTION

This invention relates generally to the field of metals joining, and more particularly to an improved laser cladding/repair process.

### BACKGROUND OF THE INVENTION

Hot gas path components of a gas turbine engine are typically formed of a superalloy material, yet they are still subject to wear, hot corrosion, foreign object damage and thermo-mechanical fatigue. For example, the radially outermost tip of a rotating turbine blade (referred to as a “squealer tip”) may experience wear due to rubbing against the blade ring surrounding the blade. It is known to repair the squealer tip by removing the worn material and adding new material by welding. Conventionally welded superalloys, particularly those with a high gamma prime content, are prone to cracking during weld pool solidification and following post weld heat treatment.

Direct selective laser sintering is a cladding process wherein a laser beam is used to melt and to consolidate powered metal onto a surface. The laser beam path is programmed to raster across a surface covered with the powder in order to deposit the material over an area that is larger than the laser beam footprint.

### BRIEF DESCRIPTION OF THE DRAWINGS

The invention is explained in the following description in view of the drawings that show:

FIG. 1 is an illustration of the conventional rastered path of a laser beam as it traverses a small radius bend during a laser cladding process.

FIG. 2 illustrates an embodiment of the invention where the footprint of a diode laser beam is changed in a sequence of individual exposures across a turbine blade tip while the power density of the beam is held constant.

FIG. 3 illustrates an embodiment of the invention where the footprint of a diode laser beam is changed continuously as it is traversed across a turbine blade tip while the power density of the beam is held constant.

FIG. 4 is a cross-sectional illustration of a superalloy material cladding process in accordance with an embodiment of the invention.

### DETAILED DESCRIPTION OF THE INVENTION

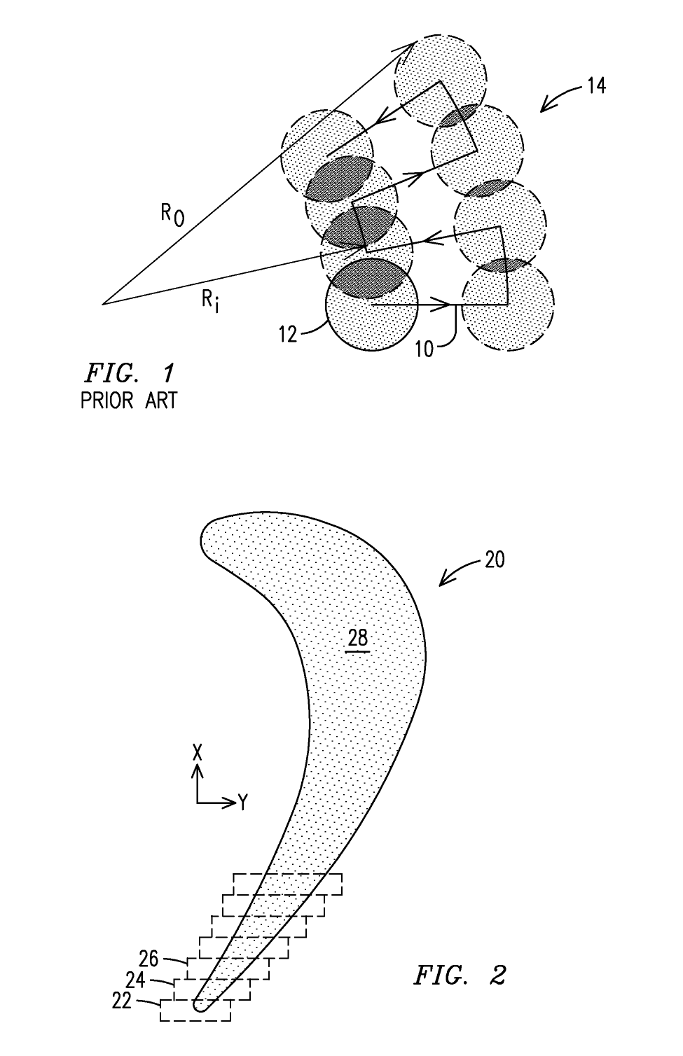

The inventors have recently developed processes that effect the crack free deposition of high gamma prime superalloy materials that previously had been considered to be unweldable (see for example co-pending U.S. Patent Application Publication US 2013/0140278 A1, incorporated by reference herein). Those processes involve scanning a laser beam across a surface to simultaneously melt powdered superalloy material and powdered flux material. The present inventors have now recognized that such processes may have limitations when depositing material on an irregularly shaped surface, such as around a small radius bend. FIG. 1 illustrates the rastered path 10 of a laser beam 12 around a relatively sharp radius bend 14. Because the diameter of the laser beam 12 is constant, there is a difference in the amount of overlap of the beam 12 between an inner radius Rᵢ of the curve 14 and an outer radius Rₒ of the curve 14, as illustrated by the overlap between the circles representing the positions of the beam 12 as it moves in the direction of the arrows along the path 10. Because there is more overlap along the inner radius Rᵢ, there is a resulting non-uniformity in the power density being applied; i.e. there is a relatively higher power density proximate the inner radius Rᵢ and a relatively lower power density proximate the outer radius Rₒ in spite of the power level and travel speed of the beam 12 being unchanged. The inventors have found this local difference in the power density to be undesirable, and that special programming of the beam path to reduce this effect can be time consuming, may result in slowing processing times, and may not be fully effective in eliminating the power density difference.

An embodiment of the present invention effective to provide a constant power density around bends of any radius during a laser cladding process is illustrated in FIG. 2, which is an end view of a gas turbine blade tip 20 undergoing a laser repair process such as laser cladding or selective laser sintering or selective laser melting. The invention exploits advances in optics developed in conjunction with diode laser systems. Adjustable optics are now commercially available to control the size and shape of a diode laser beam at focus in two dimensions. One such system is sold under the tradename “Optics Series” by Laserline Inc., Santa Clara, Calif.

FIG. 2 illustrates the blade tip 20 being heated by a sequence of rectangular diode laser beam images 22, 24, 26 as the laser beam is sequentially moved in a forward x direction relative to the blade tip 20. The figure illustrates only a portion of the surface 28 of the blade tip 20 being heated by a number of images, but one skilled in the art will appreciate that any desired area may be heated including the entire target surface 28. The surface 28 may include a powdered superalloy material and a powdered flux material that are melted by the heating to accomplish a cladding process.

Simultaneously with the progression of the laser beam in the x direction, the relative lateral positions of the images 22, 24, 26 and the blade tip 20 are concurrently controlled along a y axis to track the shape of the blade tip 20. The relative movements in both the x and y directions may be accomplished by optics motion or by part translation or by both as the sequence progresses. Furthermore, a width of the beam images 22, 24, 26 in the Y direction is controlled as the beam encounters different local portions of the blade tip 20 with different local widths so as to fully cover the local width of the blade tip 20 without excess spilling of laser energy beyond the area to be heated. In accordance with an aspect of the invention, the power level of the laser beam producing the images 22, 24, 26 is simultaneously controlled to maintain an essentially constant power density at focus among the images 22, 24, 26, thereby facilitating local consistency in the heating across the surface 28. As used herein, “essentially constant” means that each image has the same power density or a powder density within 5% of a median power density.

In the embodiment of FIG. 2, the height dimension of the beam images 22, 24, 26 is held constant along the x direction, so the total footprint (area) of the images varies linearly with changes in the width in the y direction. Thus, total laser power can be adjusted in a linear fashion in this embodiment in response to the width of the image in the y direction in order to maintain a constant power density among the beam images 22, 24, 26. In other embodiments, two dimensional adjustment of the beam image area may be made between sequential images, along with a change in power level correlating to the relative areas of the images in order to maintain a constant power density. Beam image geometries other than rectangular may also be used depending upon the capabilities of the laser energy source optics and the shape of the target surface, with appropriate changes in power of the laser being made responsive to changes in the image area such that an essentially constant power density is maintained as the heating process moves across the target surface.

One will appreciate that in some applications the power density of the beam energy may preferably be not constant across a target surface. For example, in the blade tip 20 of FIG. 2, it may be desired to provide a somewhat lower power density proximate the trailing edge of the blade tip 20 due to the limited heat carrying capacity in that region. The present invention allows any predetermined power density (e.g. constant or purposefully different) to be provided at any particular region across the target surface by appropriate control of beam power. For example, in the embodiment of FIG. 2, it may be desired to maintain an essentially constant power density across the entire blade tip 20 except for image 24 which is purposefully controlled to have a 20% lower power density and image 22 which is purposefully controlled to have a 50% lower power density. This is accomplished by controlling beam power not only in response to beam area at focus, but also by reducing beam power by a further 20% and 50% respectively for images 24 and 22 respectively.

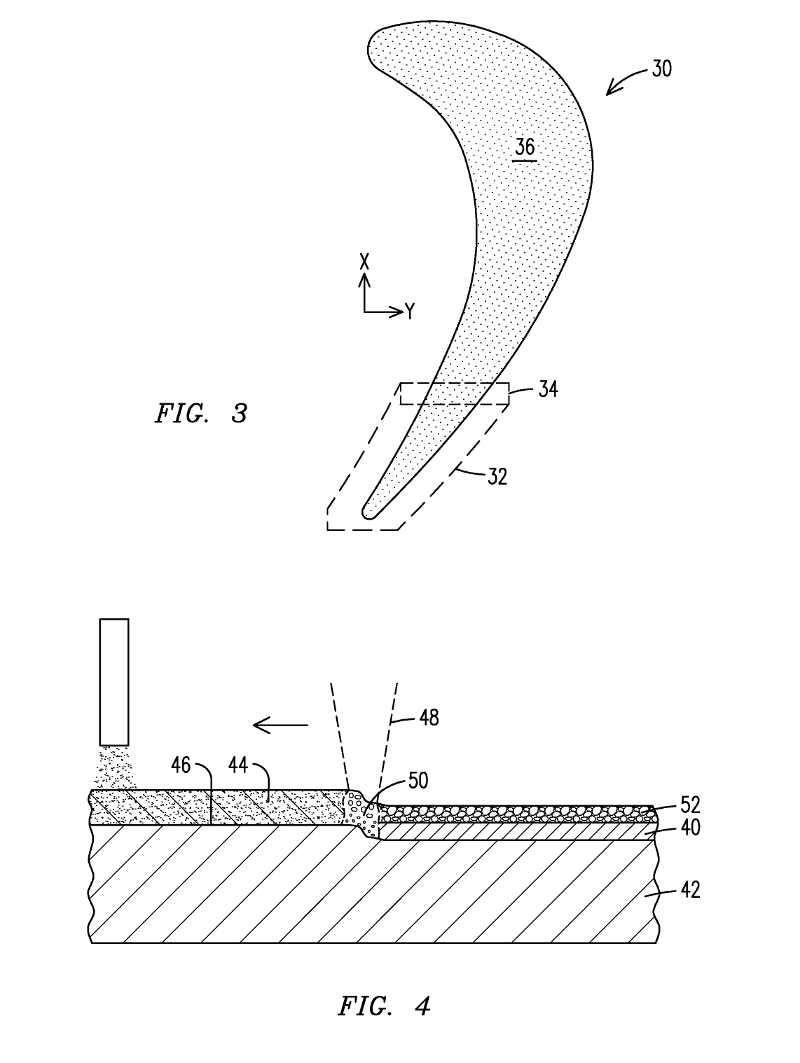

In other embodiments, a continuous diode laser beam may be moved across a target surface with the footprint and power level of the beam image being controlled in response to changes in the surface shape as the beam progresses. This embodiment is illustrated in FIG. 3 where a gas turbine blade tip 30 is being heated in a cladding process by a diode laser beam progression path 32 defined by a moving rectangular laser beam image 34. The shape of the image 34 is varied along its path in response to a local shape of the target surface 36, and a power level of the beam is controlled simultaneously with the shape of the image 34 in order to maintain an essentially constant power density across the surface 36. In this embodiment, dimensions of the image 34 may be controlled in either or both of the x and y directions, with the power level being controlled in response to the instantaneous area of the image 34. Furthermore, as discussed above with respect to FIG. 2, the power density may be controlled to any predetermined value(s) other than essentially constant, for example to reduce the power density of the beam proximate the trailing edge of the blade tip 30, or to ramp the power density proximate a starting or ending point of a heating region in order to reduce thermal gradients in a target surface.

Furthermore, in the embodiment of FIG. 3 the speed of movement of the image 34 along its path 32 may be varied, with the power level also being controlled in response to the speed of movement so that the total energy being applied to each location along the surface 36 is essentially constant. In a similar manner, in the embodiment of FIG. 2 the exposure time of the various images 22, 24, 26 may be varied and the power level controlled accordingly to provide an essentially constant heat input to each location along surface 28. Generally stated, a parameter of the beam, such as shape, width, height, area, transit speed or exposure time, is controlled in response to changes in the shape of the local surface region being exposed to the beam as the beam traverses across the surface.

FIG. 4 illustrates a process for applying a layer of superalloy cladding material 40 to a superalloy substrate 42. A layer of powdered material 44 is first applied to a surface 46 of the superalloy substrate 42. The powdered material 44 may be pre-placed on the surface 46 or it may be applied continuously just in front of a laser beam 48 as the beam is traversed across the surface 46 in a direction of the arrow. The powdered material 44 may be a mixture of particles of both superalloy material and flux material or a distinct layering of these two types of particles. As the laser beam 48 traverses across the surface 46, it heats a local region of the powdered material 44 and surface 46 to form a melt pool 50 which then solidifies into the layer of clad superalloy material 40 and an overlying layer of slag 52. The slag 52 serves to remove impurities, to protect the melt pool 50 and clad material 40 from the atmosphere, to shape the melt pool 50 and to control the rate of cooling, thereby providing crack free deposition of difficult to weld high gamma prime content superalloy materials.

While various embodiments of the present invention have been shown and described herein, it will be obvious that such embodiments are provided by way of example only. Numerous variations, changes and substitutions may be made without departing from the invention herein. For example, energy other than laser energy may be used to heat the target surface, such as an electron beam or a beam of sonic energy. Further, the invention may be used with difficult to weld superalloy materials or any other material capable of being melted and re-solidified on a surface. The process may be implemented across an entire surface or a target surface which forms only part of a complete surface. Accordingly, it is intended that the invention be limited only by the spirit and scope of the appended claims.

The invention claimed is:

1. A method comprising:
traversing a laser beam across a target surface to progressively melt local regions of the surface;
controlling an area of the laser beam at focus during the step of traversing in response to a local shape of the target surface at the respective local melt regions; and
controlling a power level of the laser beam in response to the area of the laser beam at focus in order to provide a desired power density of the laser beam across the target surface.

2. The method of claim 1, further comprising traversing a series of laser beam images across the target surface to sequentially melt the local regions of the surface.

3. The method of claim 2, further comprising controlling the power level of the laser beam for each image in response to an area of the respective image at focus.

4. The method of claim 3, further comprising controlling the power level of the laser beam for each image in response to a time of exposure of the target surface to the respective image.

5. The method of claim 1, further comprising:
traversing a diode laser beam having a rectangular shape at focus across the target surface;
controlling a width of the laser beam in a direction transverse to a direction of traversal of the images in response to a local width of the target surface; and
controlling the power level of the laser beam in response to the width of the laser beam to provide the essentially constant power density.

6. The method of claim 5, further comprising controlling the laser beam to produce a sequential series of rectangular shaped images across the target surface in the direction of traversal with each image having a width responsive to the local width of the target surface.

7. The method of claim 6, further comprising;
controlling a height of the respective laser beam images in the direction of traversal of the images; and
controlling the power level of the laser beam for each image in response to the area of the respective rectangular shaped image at focus.

8. The method of claim 1, further comprising:
traversing a continuous laser beam across the target surface;
continuously controlling the area of the laser beam at focus in response to a local shape of the target surface; and
continuously controlling the power level of the laser beam in response to the area of the laser beam at focus in order to provide the essentially constant power density across the target surface.

9. The method of claim 1, further comprising controlling the power level of the laser beam in response to the area of the laser beam at focus in order to provide an essentially constant power density of the laser beam across the target surface.

10. The method of claim 1, further comprising:
providing powdered superalloy material and powdered flux material on the target surface prior to the step of traversing; and
progressively melting the powdered superalloy and flux materials with the local melt regions of the surface; and
allowing the melted superalloy and flux materials to cool and to solidify to form a layer of superalloy cladding material covered by a layer of slag on the target surface.

11. A method comprising:
traversing an energy beam across a target surface, a local shape of respective portions of the surface exposed to the energy beam changing as the beam is traversed across the surface;
controlling a parameter of the energy beam in response to the local shape of the respective portions of the surface being exposed; and
controlling a power level of the energy beam in response to changes in the parameter of the energy beam such that a power density of the energy beam at focus on the target surface is essentially constant as the beam traverses across the surface.

12. The method of claim 11, further comprising:
traversing the energy beam across the target surface in a direction of traversal as a series of laser beam images;
controlling respective widths of the images in a direction transverse to the direction of traversal in response to a local width of the target surface being exposed; and
controlling the power level of the laser beam in response to the width of the respective image.

13. The method of claim 12, further comprising:
controlling respective heights of the images in the direction of traversal; and
controlling the power level of the diode laser beam in response to the height of the respective image.

14. The method of claim 11, further comprising:
traversing the energy beam across the target surface as a series of laser beam images; and
controlling the power level of the laser beam for each image in response to a time of exposure of the target surface to the respective image.

15. The method of claim 11, further comprising:
traversing the energy beam as a continuous laser beam across the target surface;
continuously controlling an area of the laser beam at focus in response to the local shape of the respective portions of the surface being exposed; and
continuously controlling the power level of the laser beam in response to the area of the laser beam at focus in order to provide the essentially constant power density across the target surface.

16. The method of claim 11, further comprising:
providing powdered superalloy material and powdered flux material on the target surface prior to the step of traversing; and
progressively melting the powdered superalloy and flux materials across the surface with the traversed energy beam; and
allowing the melted superalloy and flux materials to cool and to solidify to form a layer of superalloy cladding material covered by a layer of slag on the target surface.

17. A method comprising:
heating a powdered surface by sequentially progressing a plurality of laser beam images across the powdered surface;
controlling an area of each image in response to a respective shape of an area of the powdered surface being heated by the respective image; and
controlling a power level of a laser used to generate the images so that a power density of each image is a desired value.

18. The method of claim 17, further comprising:
utilizing a diode laser to generate the images in a rectangular shape;
controlling each image to have a same height as other images in a direction of forward progression; and
controlling each image to have a width responsive to a local width of the powdered surface being heated by the respective image.

19. The method of claim 18, further comprising controlling the power level of the laser beam in a linear relationship with the width of the respective image in order to provide an essentially constant power density among all of the images.

20. The method of claim 17, wherein the heating step further comprises heating a surface of powdered superalloy material and powdered flux material disposed on a surface of a superalloy substrate material.
